(19) United States
(12) Patent Application Publication
(10) Pub. No.: US 2013/0134276 A1
(43) Pub. Date: May 30, 2013

(54) POWER TOOL AND ACCESSORY STORAGE SYSTEM

(71) Applicants: Benjamin Luke VAN DER LINDE, Heatherton (AU); David Leigh SCRIMSHAW, Heatherton (AU); Paul Francis CONNOR, Heatherton (AU); Paul MILLER, Heatherton (AU); Ben EYERS, Heatherton (AU); Sion NETZLER, Heatherton (AU); Lucas LASTMAN, Heatherton (AU)

(72) Inventors: Benjamin Luke VAN DER LINDE, Heatherton (AU); David Leigh SCRIMSHAW, Heatherton (AU); Paul Francis CONNOR, Heatherton (AU); Paul MILLER, Heatherton (AU); Ben EYERS, Heatherton (AU); Sion NETZLER, Heatherton (AU); Lucas LASTMAN, Heatherton (AU)

(73) Assignee: DEMAIN TECHNOLOGY PTY LTD, Heatherton (AU)

(21) Appl. No.: 13/594,248

(22) Filed: Aug. 24, 2012

Related U.S. Application Data
(63) Continuation of application No. PCT/AU2011/000208, filed on Feb. 25, 2011.

(30) Foreign Application Priority Data
Feb. 25, 2010 (AU) 2010900807
Feb. 25, 2010 (AU) 2010900808
Feb. 25, 2010 (AU) 2010900809
Feb. 26, 2010 (AU) 2010900831
Nov. 29, 2010 (AU) 2010905259

(51) Int. Cl. F16M 13/02

(52) U.S. Cl. CPC F16M 13/02
USPC 248/311.2

(57) ABSTRACT

A connection arrangement for releasably connecting a device receptacle and a support for attachment to a surface. The connection arrangement includes a first connection interface associated with the support including a pair of spaced apart supporting surfaces and a second connection interface associated with the device receptacle including a pair of spaced apart support surface engaging surfaces. Also provided is a storage system for storing devices adjacent a surface including a support for attachment to the surface, at least one device receptacle for receiving a device, wherein the device receptacle is releasably connectable to the support. Preferred forms of the invention include device receptacles for containing hand held power tools, hand tools and parts and accessories therefore.

### CROSS REFERENCE TO RELATED APPLICATION

This application is a continuation application based on PCT Patent Application No. PCT/AU2011/000208, filed Feb. 25, 2011, whose priority is claimed on Australian Patent Application Nos. 2010900807 filed Feb. 25, 2010, 2010900808 filed Feb. 25, 2010, 2010900809 filed Feb. 25, 2010, filed 2010900831 filed Feb. 26, 2010 and 2010905259 filed Nov. 29, 2010, the entire content of which is hereby incorporated by reference.

### FIELD OF THE INVENTION

The present invention relates to a storage system for tools, such as handheld power tools. The present invention also relates to a receptacle or case for receiving and carrying a tool, such as a handheld power tool.

### BACKGROUND OF THE INVENTION

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Power tools are often sold in packaging that is intended for disposal after purchase and removal of the tool from the packaging. Such packaging may be formed out of cardboard and/or a polymer container that protections the tool during transportation and storage prior to sale. Some power tools are packaged in a storage case that is intended to be used as a container for storing the power tool throughout the useful life of the power tool. Such cases can be in the form of a base and a closure wherein the base and the closure are attached to each other by a hinge. The base may include one or more recesses for receiving the power tool and other accessories associated with the power tool such as a charger, battery, tool bits and the like.

Given the variety of ways in which power tools are packaged marketed and sold to consumers it is not uncommon for an individual to own a variety of power tools of which some are provided with a storage case and some of which are not. Accordingly, it is not uncommon for an individual to store power tools in a haphazard way with some stored in a power tool case and others loosely stored in cupboards, on shelves or in boxes or containers.

As the cost of power tools has diminished, and continues to diminish, it is not uncommon for an individual in a domestic environment to possess a wide variety of power tools for performing a wide variety of functions. For example, it is not uncommon for an individual to possess any one or more of as a handheld cordless power drill, a handheld AC powered high speed drill, a handheld percussion/hammer drill, a handheld angle grinder, a handheld circular saw, a handheld jigsaw, a handheld disc sander and/or belt sander to name but a few. As these power tools may be packaged in cases for permanently storing the power tool and others in disposable containers it is common for an individual to have such tools stored in an area, such as a garage or shed, in a disorganised state with some power tools in storage cases and others provided loosely in cupboards, on shelves or in boxes or containers. In general the storage of power tools in a domestic environment is haphazard and disorganised.

### SUMMARY OF THE INVENTION

An object of the present invention is to provide a system for storage of devices in and area where they may be used, and transport to and from an area where they may be used.

Another object of the present invention is to provide a system for storage and transport of devices that is suitable for professionals and amateurs.

Another object of the present invention is to provide a system for storage and transport of devices and accessories that allows their ready interchange and rearrangement.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In one aspect, the present invention provides a connection arrangement for releasably connecting a device receptacle and a support for attachment to a surface, the connection arrangement including:
a first connection interface associated with the support including a pair of spaced apart supporting surfaces
a second connection interface associated with the device receptacle including a pair of spaced apart support surface engaging surfaces
a first one of the support surface engaging surfaces is removably engageable with a first one of the supporting surfaces to thereby support at least part of the weight of the device receptacle thereon
the second one of the support surface engaging surfaces is removably engageable with the second one of the supporting surfaces to positively retain the first and second connection interfaces together.

In an embodiment, the spaced apart supporting surfaces are outwardly curved and the spaced apart support surface engaging surfaces are inwardly curved.

In another embodiment, the largest overall dimension between the pair of spaced apart supporting surfaces is greater than the dimension between the pair of spaced apart support surface engaging surfaces.

In yet another embodiment, the second one of the support surface engaging surfaces is formed out of a resiliently deflectable material. An advantage of this embodiment is that it provides for a positive and secure attachment of the device receptacle to the support by providing a snap fit engagement between the first and second connection interfaces.

In another embodiment, the support is an elongated member that is configured to extend horizontally when attached to a surface and includes a plurality of horizontally adjacent first connection interfaces for releasable connection of a plurality of horizontally adjacent receptacles to the support.

In a preferred embodiment, at least one of the device receptacles is a hand held tool receptacle.

In another aspect, the present invention provides a storage system for storing devices adjacent a surface including:
a support for attachment to the surface
at least one device receptacle for receiving a device,
the device receptacle being releasably connectable to the support.

An advantage of the invention is that it provides a system for the organised storage of devices such as power tools, particularly hand held power tools, adjacent to a surface such as a wall surface in a garage, shed or some other room. In this regard, the invention provides one or more receptacles that each receive a device such as a hand held power tool and the one or more receptacles can be releasably attached to a support that, in turn, is attached to the wall surface to thereby provide organised storage of the devices, such as hand held power tools, on the wall surface in a manner that is organised, attractive and provides ease of access to the power tools. Another advantage is that the system provides a portable receptacle for containing and securing the device, such as a power tool, during transport.

In yet another form, the support is an elongated member that is configured to extend horizontally when attached to a surface and includes a plurality of the horizontally adjacent first connection interfaces for releasable connection of a plurality of horizontally adjacent receptacles to the support.

In one form, the device receptacle includes a base portion and a closure member connected to the base portion, the base portion includes an internal space for receiving the device and the closure member is movable relative to the base portion between an open position to provide access to the internal space and a closed position to enclose the internal space.

In one form, the device receptacle includes a device interface member within the internal space of the receptacle, the interface member including a device interface surface defining a recess that is shaped to receive the device and conform with an exterior surface of the device to thereby restrict movement of the device relative to the interface member.

In another form, the interface member is releasably connectable to the receptacle within the internal space of the receptacle.

The system can further include a device accessory receptacle that is integrally formed with the device receptacle for containing accessories for use with the device.

The system can further include a device accessory receptacle that is releasably connectable to the device receptacle for containing accessories for use with the device.

In one form, the device accessory receptacle includes a mounting portion that is releasably mountable to the device receptacle and an accessory carrier member including one or more accessory carrying recesses, the accessory carrier member being slidably connected to the mounting portion and slidable between a closed position to enclose the one or more accessory carrying recesses and an open position to provide access to the one or more accessory carrying recesses.

The system can further include a shelf member that is connectable relative to the support.

In an embodiment, the shelf has a planar surface that when the support is attached horizontally to a wall surface and the shelf is connected relative to the support the planar surface of the shelf is horizontal.

In an embodiment, the shelf includes a releasably connectable or an integral light source.

In yet another embodiment, the system further includes one or more article receptacles including a mounting portion that is releasably mountable to the shelf and an article carrier member including one or more article carrying recesses, the article carrier member being slidably connected to the mounting portion and slidable between a closed position to enclose the one or more article carrying recesses and an open position to provide access to the one or more article carrying recesses.

In an embodiment, the system includes a power board including a plurality of electrical socket connectors releasably connectable to the shelf.

The system can further include a cover that is releasably connectable relative to the support and pivots relative to the support between a closed position in which the cover encloses the device receptacle when connected to the support and an open position for providing access to the device receptacle when connected to the support.

In a preferred form, at least one of the device receptacles includes an audio device containing an electronic system that plays an audio source over loudspeakers.

The system can further include an electronic device module that includes an electronic display and user interface and is connectable to a computer network and is capable of downloading data.

In a preferred form, the device receptacle is a hand held tool receptacle. In another form, the device is a hand held electrically powered device.

In a particularly preferred embodiment the storage system is suitable for storing power tools, the system including:
a frame for demountably supporting multiple carry cabinets, each carry cabinet being adapted to receive a power tool, characterised in that,
said power tools can be inserted or removed through a port in their respective carry cabinet while said multiple carry cabinets are mounted on the frame, and
said power tools can be transported in their respective carry cabinets when each of said carry cabinets are demounted from the frame.
The frame to which the carry cabinets are mounted may be fixed free-standing, or mobile free-standing. Alternatively, the frame may be attached to a fixed structure such as a wall, or form part of a fixed structure.

Typically the carry cabinets of the storage system can be changed between a mounted and a demounted configuration respectively by engaging and disengaging a latch between the carry cabinet and frame. In a particularly preferred embodiment a simple form of latch is used, comprising one or more rails and correspondingly shaped slot(s). The rail may be integral with, or alternatively attached to the frame. The slot of the latch may be defined by a piece of metal or other material sharply curved to form a hook.

The storage system may also include one or more carry cabinets adapted to include a device chosen from the group comprising a power source, a power outlet having a retractable cord, a light, an audio device, a communications interface, a charging mat for an electronic device or combinations thereof.

In another aspect, the invention provides a device receptacle for containing a device and configured for releasable connection to a support attached to a surface, the device receptacle including:
a base portion and a closure member connected to the base portion, the base portion includes an internal space for receiving a device and the closure member is movable relative to the base portion between an open position to provide access to the internal space and a closed position to enclose the internal space,
a connecting portion associated with the base portion that is cooperable with the support for releasably connecting the device receptacle to the support.

In one form, the connecting portion includes a flange that is receivable within an opening of the support and contacts a supporting surface adjacent to the opening when the device receptacle is connected to the support whereby the device receptacle is at least partially supported by the contact between the flange and the supporting surface.

The device receptacle can further include a handle connected to the base portion or the closure member for carrying the device receptacle when the device receptacle is disconnected from the support.

In one form, the base portion includes one of a clip or a clip receiving portion for releasable connection respectively with a clip receiving portion or a clip of any one of a plurality of interchangeable device interfaces positioned within the internal space of the base portion wherein each device interface is shaped to receive one type of device and to conform to an external surface of the device to thereby restrict movement of the device relative to the interface member.

In yet another form, the closure member is pivotally coupled to the base portion and pivots relative to the base portion between an open position to provide access to the internal space and a closed position to enclose the internal space.

In a preferred form, the device is a hand held power tool. In another form, the device is a hand held electrically powered device.

### BRIEF DESCRIPTION OF THE DRAWINGS

The present invention will now be described in more detail with reference to the following figures. The following figures represent embodiments of the invention in the form of a storage system for handheld power tools and a receptacle for receiving a handheld power tool and for the sake of convenience the present invention will be described below in detail with reference to this embodiment. It is to be appreciated, however, that the present invention may be suitable for use with handheld power drills, handheld power saws, handheld power screwdrivers, handheld percussion/hammer drills, handheld angle grinders, handheld disc saws, handheld power sanders and other handheld electrical devices such as a light emitting device to name but a few.

FIG. 1 illustrates a perspective view of a storage system for handheld power tools including plurality of tool receptacles respectively receiving a handheld power tool, a support attached to a surface, in the form of a wall, wherein the tool receptacles are connected to the support and thereby releasably mounted to the wall.

FIG. 2 illustrates a perspective view of the support and one tool receptacle of the storage system of FIG. 1.

FIG. 3A illustrates a perspective view of the support of the storage system of FIG. 1.

FIG. 3B illustrates a perspective view of a face plate of the support of the storage system of FIG. 1.

FIG. 3C illustrates a perspective view of a base plate of the support of the storage system of FIG. 1.

FIG. 3D illustrates a top view of the support of the storage system of FIG. 1 including a ledge, an opening and a supporting surface of an interface zone of the support.

FIG. 3E illustrates a bottom view of the support of the storage system of FIG. 1 including a second ledge, a second opening and a second supporting surface of the interface zone of the support.

FIG. 4 illustrates a perspective view of the support, one tool receptacle and one tool accessory receptacle of the storage system of FIG. 1.

FIG. 5 illustrates a perspective view of the support, one tool receptacle and one tool accessory receptacle of the storage system of FIG. 1 as well as a shelf member connected to the wall relative to the support and thereby mounted to the wall.

FIG. 6 illustrates a perspective view of the support and a plurality of tool receptacles of the storage system of FIG. 1 as well as a plurality of tool accessory receptacles and a shelf member connected relative to the support.

FIG. 7 illustrates a perspective view of the support and a plurality of tool receptacles of the storage system of FIG. 1 as well as a plurality of tool accessory receptacles, a shelf member connected relative to the support and a cover connected to the support wherein the cover includes a fixed member and a shutter member wherein the shutter member is pivotally attached to the fixed member and is pivoted to an open position allowing access to the tool receptacles and the tool accessory receptacles connected to the support.

FIG. 8 illustrates a perspective view of the storage system of FIG. 1 cover of FIG. 7 and a power board module and an audio module connected to the support wherein the power board module includes electrical socket connectors and an extension lead extending therefrom.

FIG. 9 illustrates a perspective view of the storage system of FIG. 1 including the cover of FIGS. 7 and 8 wherein the cover is in a closed position.

FIG. 10 illustrates a perspective view of the storage system of FIG. 1 including the shelf member of FIGS. 5 to 9 connected relative to the support wherein the shelf member includes a light source for projecting light onto a workbench.

FIG. 11 illustrates a perspective view of the storage system of FIG. 1 including the support, the tool receptacle and the shelf member of FIGS. 5 to 10 connected relative to the support wherein the shelf member includes a substantially planar, upwardly facing and horizontal surface supporting an article in the form of a paint tin.

FIG. 12 illustrates a perspective view of a storage system for handheld power tools in accordance with another embodiment including one tool receptacle for receiving a handheld power tool, a support attached to a surface, in the form of a wall, wherein the tool receptacle is connected to the support and thereby releasably mounted to the wall.

FIG. 13 illustrates a perspective view of a reverse side of the support and the tool receptacle of the storage system of FIG. 12.

FIG. 14 illustrates a side view of the tool receptacle of the storage system of FIG. 12.

FIG. 15 illustrates a perspective view of the tool receptacle of the storage system of FIG. 12.

FIG. 16 illustrates another perspective view of the tool receptacle of the storage system of FIG. 12.

FIG. 17 illustrates a perspective view of the support of the storage system of FIG. 12.

FIG. 18 illustrates a perspective view of another embodiment including a support to which can be mounted a plurality of tool receptacles, a plurality of tool accessory receptacles, a shelf member connected relative to the support, a pair of power board modules and a light source releasably connectable to the shelf member and a cover connected to the support wherein the cover includes a fixed member and a shutter member wherein the shutter member is pivotally attached to the fixed member and is pivoted to a closed position preventing access to tool receptacles and tool accessory receptacles to be connected to the support.

FIG. 19 illustrates a perspective view of the embodiment of FIG. 18, wherein the shutter member is pivoted to an open position allowing access for tool receptacles and tool accessory receptacles to be connected to the support.\

FIG. 20 illustrates a perspective view of the embodiment of FIG. 18 including the support, the shelf member connected relative to the support and the pair of power board modules and light source connectable to the shelf member wherein the cover is removed.

FIG. 21 illustrates a perspective view of the embodiment of FIG. 18 including the support, the shelf member and the pair of power board modules and light source releasably connectable to the shelf member wherein the cover is removed.

FIG. 22 illustrates a perspective view of the embodiment of FIG. 18 including the support, the shelf member and one of the pair of power board modules and the light source removed from the shelf member.

### DETAILED DESCRIPTION

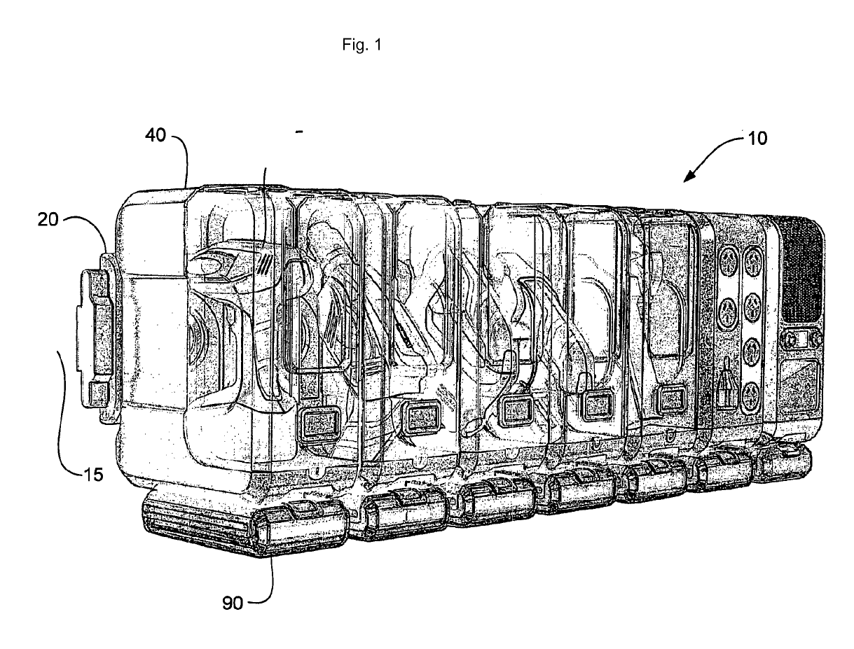

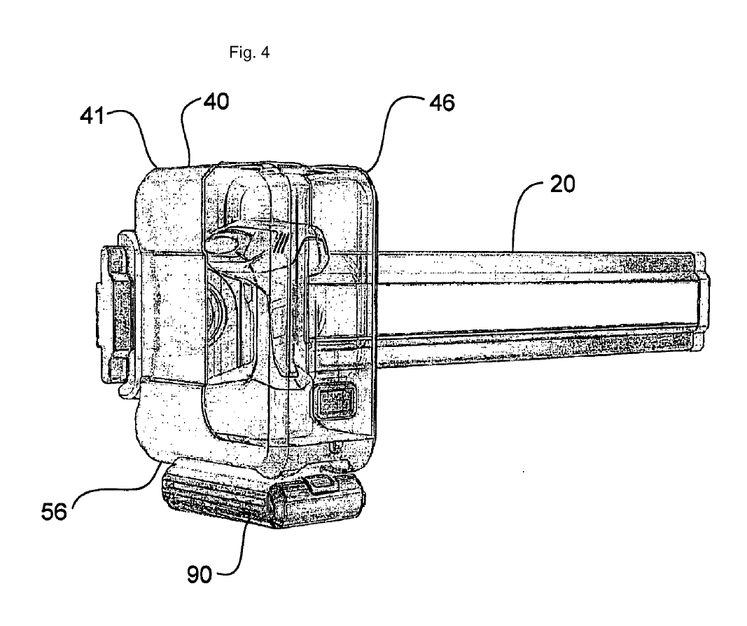

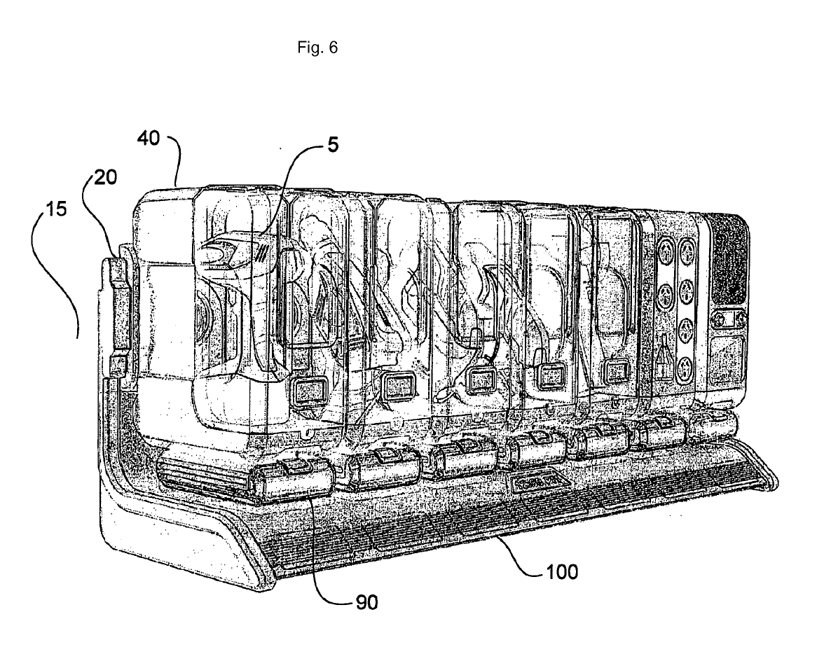

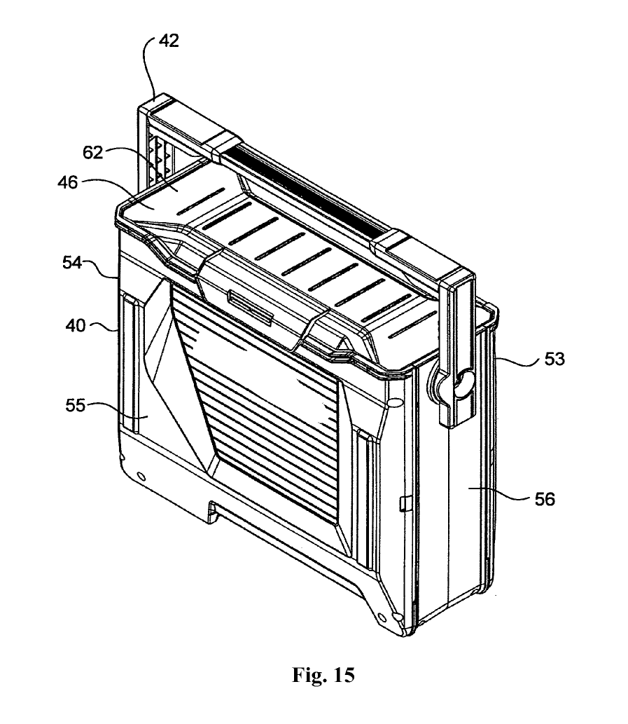

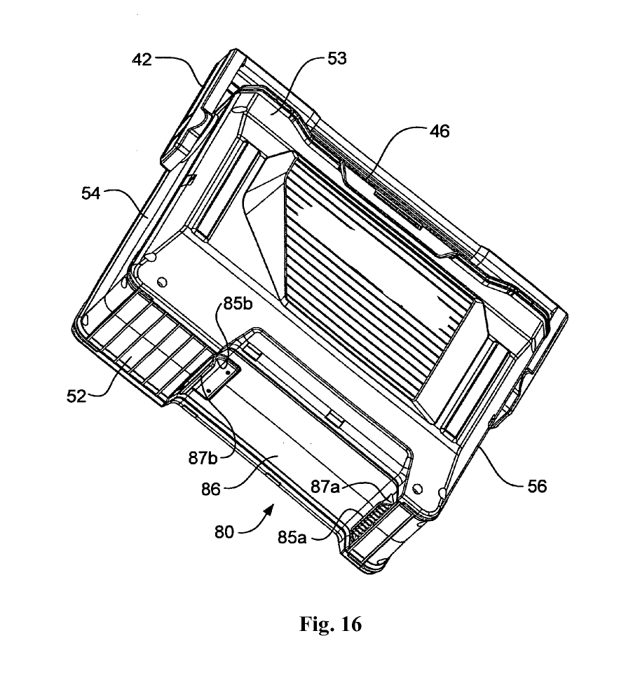

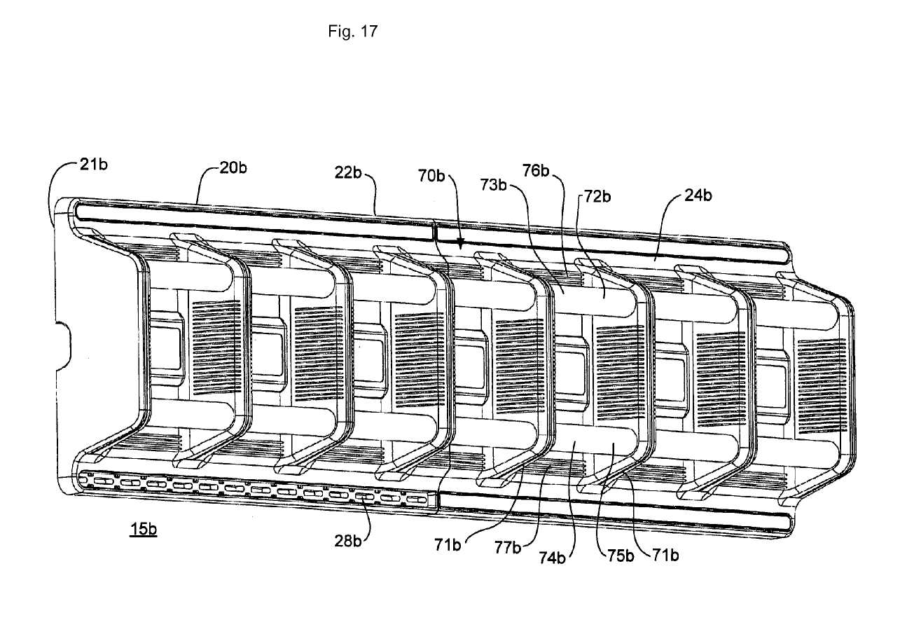

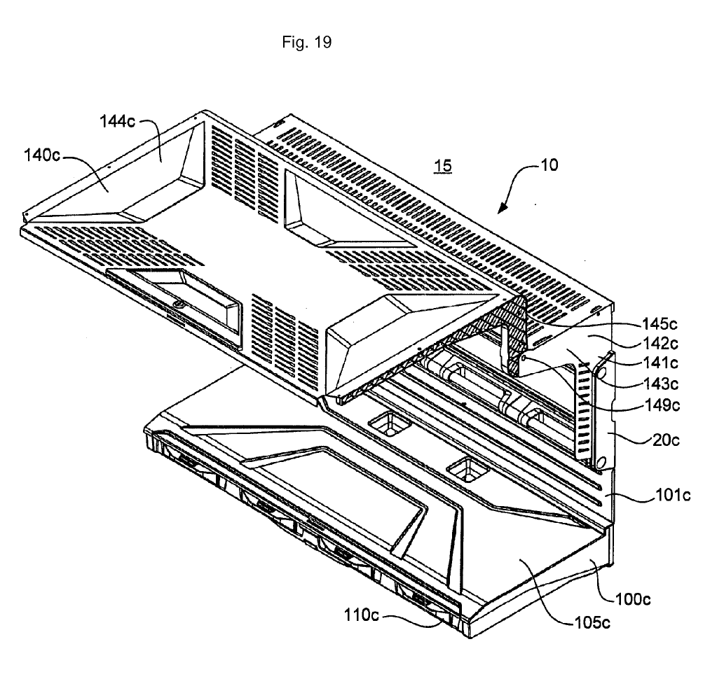

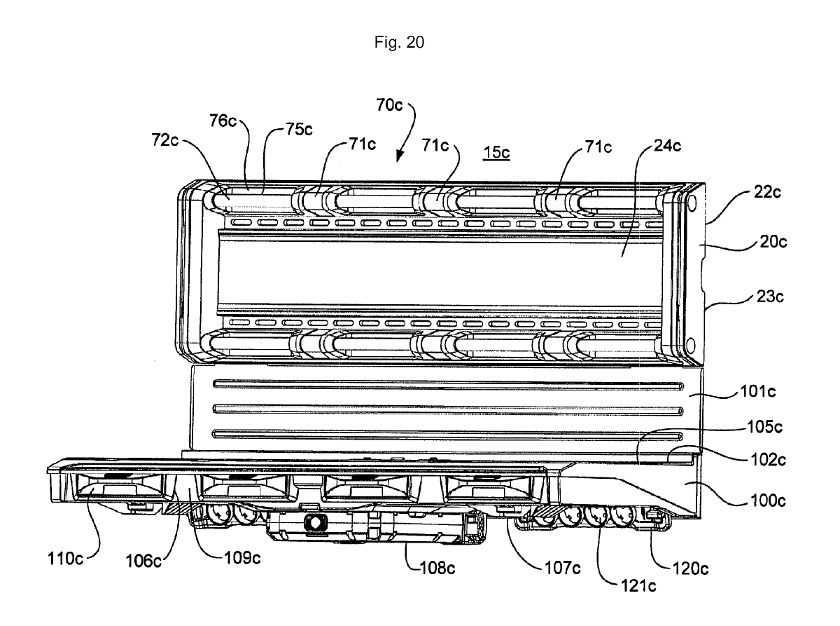

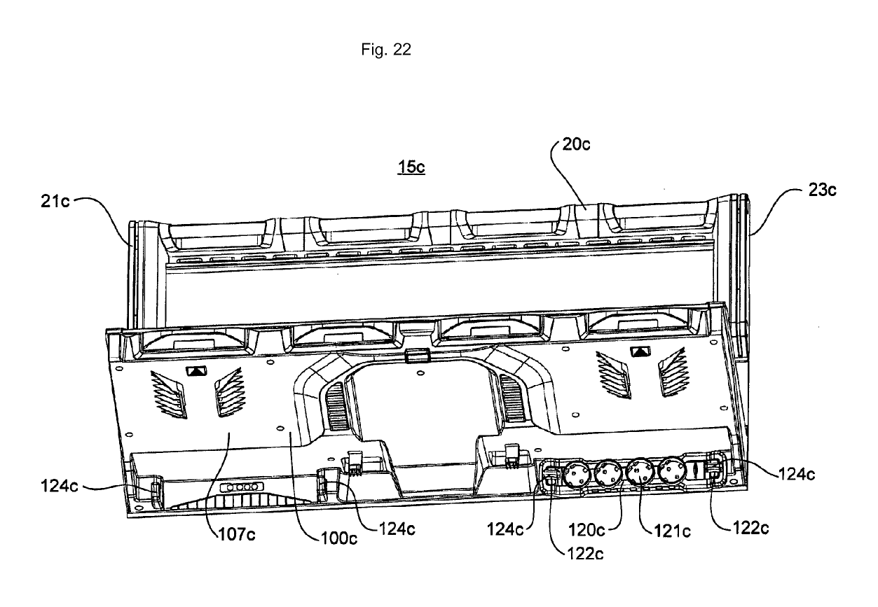

Referring to FIGS. 1 to 22 there is shown embodiments of a storage system 10 in accordance with the invention. The storage system 10 broadly includes a support 20 that is configured for attachment to a surface 15, which may be a wall or another upright surface, and at least one device receptacle 40 that is releasably connectable to the support 20. The storage system 10 is broadly for storing devices, which may include handheld power tools 5 or other form of electrically powered devices, in an organised manner at a location adjacent to the surface 15, such as a wall surface. Although the system 10 is suitable for storing devices of virtually any kind it will be convenient to hereinafter describe the invention in the context of its suitability for storing hand held power tools 5. The storage system 10 also facilitates easy access to the power tools 5 and easy transport of any one of more of the power tools 5 away from the location in which they are stored.

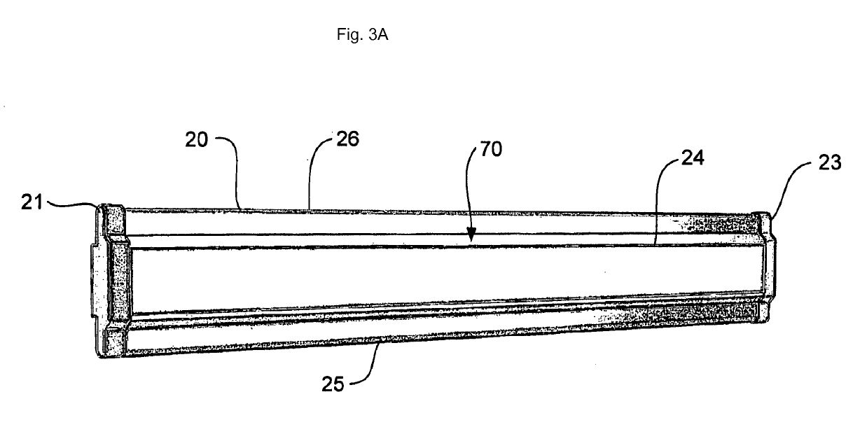

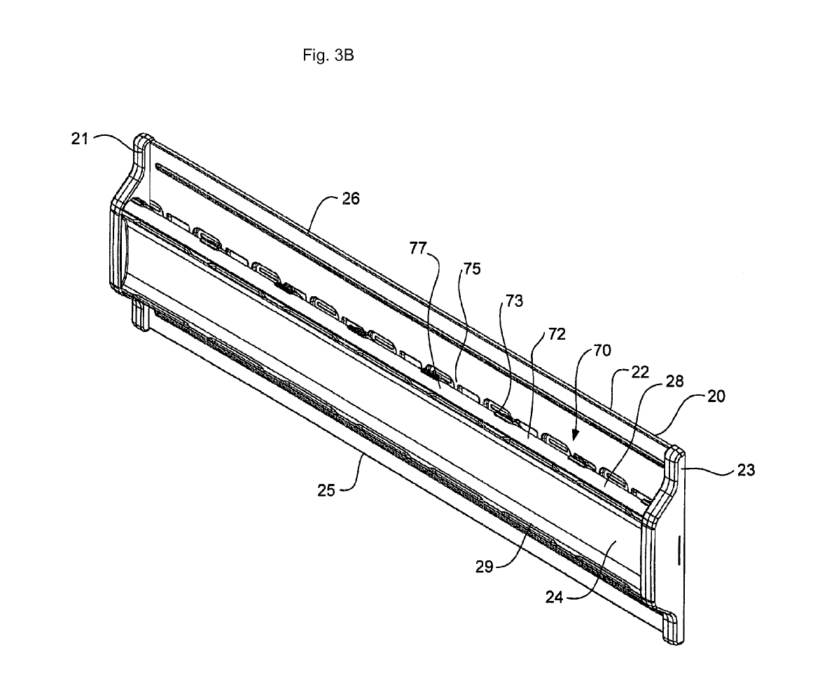

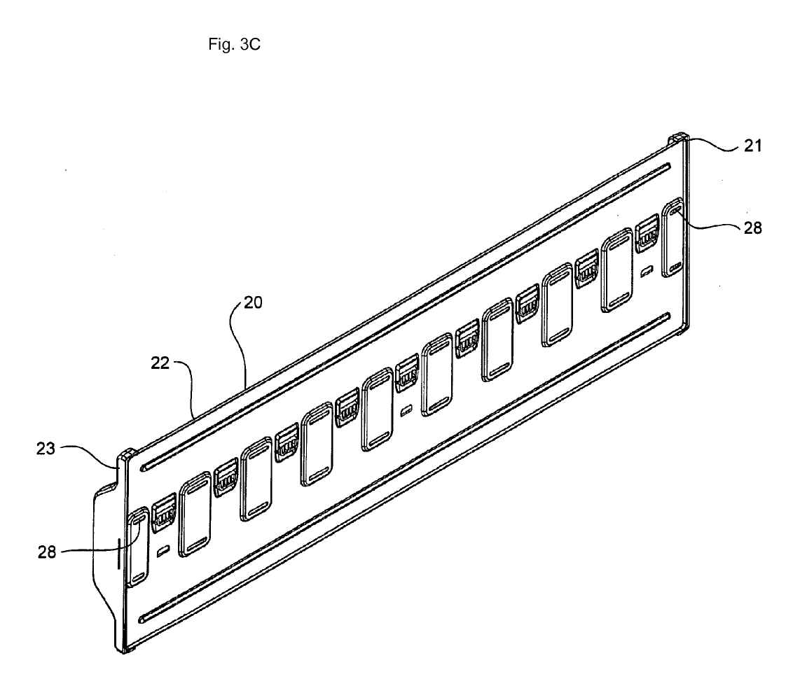

Referring to FIGS. 3A to 3E, the support 20 is a generally elongated member extending from a first end 21 to a second end 23. The support 20 includes a generally planar and elongated base plate 22 that extends from the first end 21 to the second end 23 and includes a means of attachment to the surface 15, such as a plurality of apertures 28 for receiving one or more fasteners therethrough. Attached to the base plate 22 is an elongated face plate 24 extends from the first end 21 to the second end 23. When the support 20 is attached to the surface 15 the face plate 24 faces away from the surface 15 whereas the base plate 22 faces towards the surface 15. The base plate 22 and the face plate 24 are configured so that when the support 20 is attached to the surface 15 the base plate 22 and the face plate 24 extend in a generally horizontal direction. The support 20 includes an interface 70 that is adapted for interfacing with a second interface 80 of any one or more of the receptacles 40 in a manner that will be described herein below.

The first interface 70 extends continuously along the support 20 from the first end 21 to the second end 23 such that when the support 20 is attached to the surface 15 the interface zone 70 extends continuously in a horizontal direction for releasable connection of a plurality of horizontally adjacent receptacles 40 as illustrated in FIGS. 1, 6, 7 and 8. The first interface 70 includes a ledge 72 extending continuously along the face plate 24 in the horizontal direction from the first end 21 to the second end 23. The ledge 72 faces generally upwardly and includes either a single elongate opening 75 therethrough or may otherwise include a plurality of openings along the length of the ledge 72. The ledge 72 also includes a supporting surface 77 immediately adjacent to the opening 75 and on a side of the opening 75 opposite from the base 22 which is the same side of the opening 75 as the face plate 24. The ledge 72 extends from the first end 21 to the second end 23 and is arranged horizontally along the face plate 24 when the support 20 is horizontally attached to the surface 15. The ledge 72 is located intermediate of a bottom edge 25 and a top edge 26 of the base plate 22 and at a top edge 28 of the face plate 24. The ledge 72 includes a series of ridges 73 arranged at spaced apart intervals along the length of the ledge 72 and along the length of the opening 75.

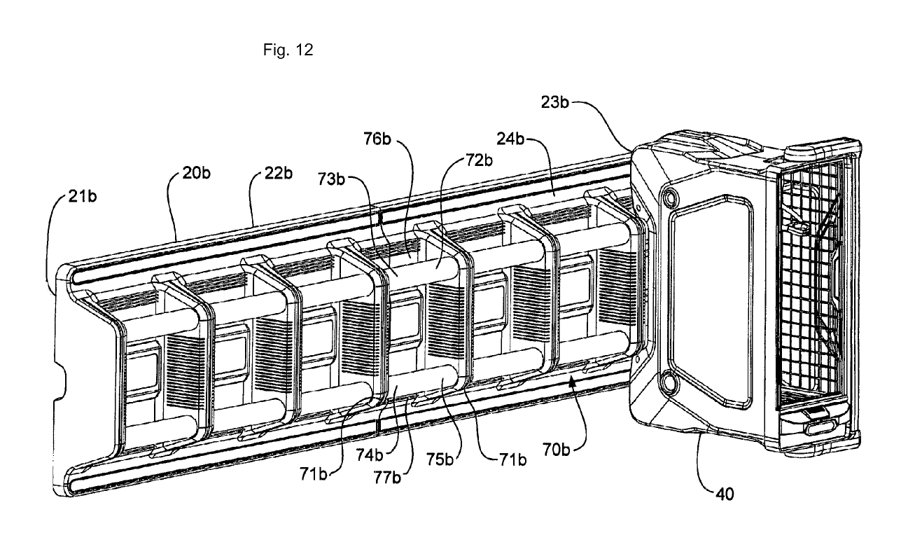

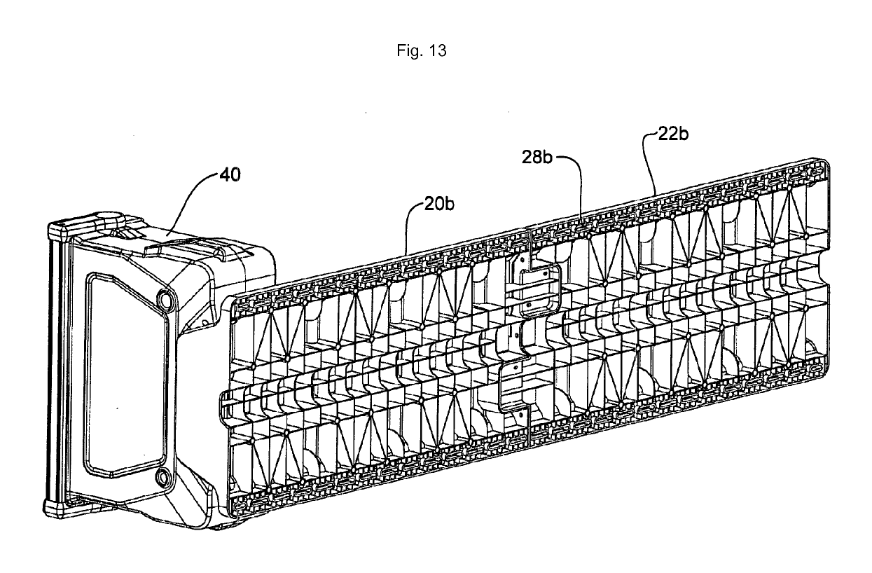

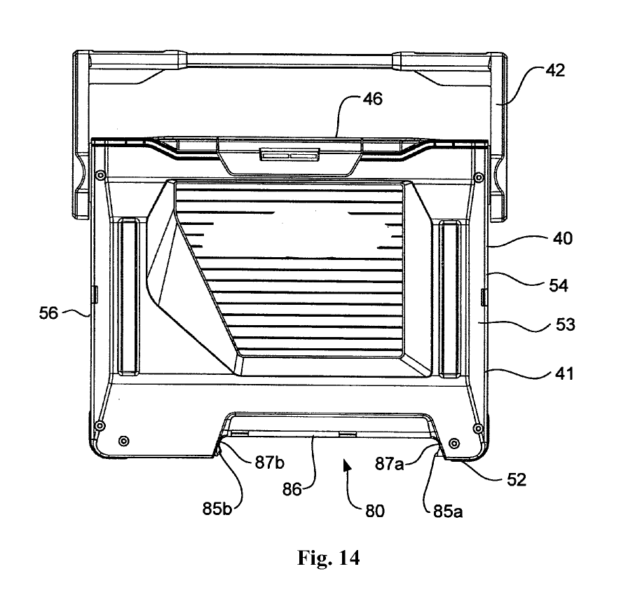

Referring to FIGS. 12, 13 and 17, another embodiment of the support 20b is illustrated. The support 20b is a generally elongated member extending from a first end 21 b to a second end 23b. The support 20b includes a generally planar and elongated base plate 22b that extends from the first end 21 b to the second end 23b and includes a means of attachment to a surface 15b, such as a wall. The means of attachment to the surface 15b includes, as shown in FIG. 13, as a plurality of apertures 28b for receiving one or more fasteners therethrough. Attached to the base plate 22b is an elongated face plate 24b extends from the first end 21 b to the second end 23b. When the support 20b is attached to the surface 15b the face plate 24b faces away from the surface 15b whereas the base plate 22b faces towards the surface 15b. The base plate 22b and the face plate 24b are configured so that when the support 20b is attached to the surface 15b the base plate 22b and the face plate 24b extend in a generally horizontal direction. The support 20b includes a first interface 70b that is adapted for interfacing with any one or more of the receptacles 40b in a manner that will be described herein below.

The first interface 70b extends continuously along the support 20b from the first end 21 b to the second end 23b such that when the support 20b is attached to the surface 15b the first interface 70b extends continuously in a horizontal direction for releasable connection of a plurality of horizontally adjacent receptacles 40b. The first interface 70b includes a plurality of horizontally spaced apart wall members 71 b that are upstanding from the face plate 24b and, between each adjacent pair of wall members 71 b, are a pair of elongated support members 72b, 74b that extend between and to each of the adjacent pair of wall members 71 b. The elongated support members 72b, 74b are connected at opposite ends to each of the adjacent pair of wall members 71 b. The elongated support members 72b, 74b respectively include a rounded supporting surface 73b, 75b extending in a substantially horizontal direction between and to each of the adjacent pair of wall members 71 b. One of the support members 72b is positioned vertically above the other one of the support members 74b and the supporting surface 73b of the upper one of the support members 72b is substantially convex or outwardly curved in shape and faces generally upwardly. The supporting surface 75b of the lower one of the support members 74b is substantially convex or outwardly curved in shape and faces generally downwardly. The support members 72b, 74b are spaced apart from the face plate 24b such that an upwardly oriented opening 76b is provided between the upper support member 72b and the face plate 24b and a downwardly oriented opening 77b is provided between the lower support member 74b and the face plate 24b.

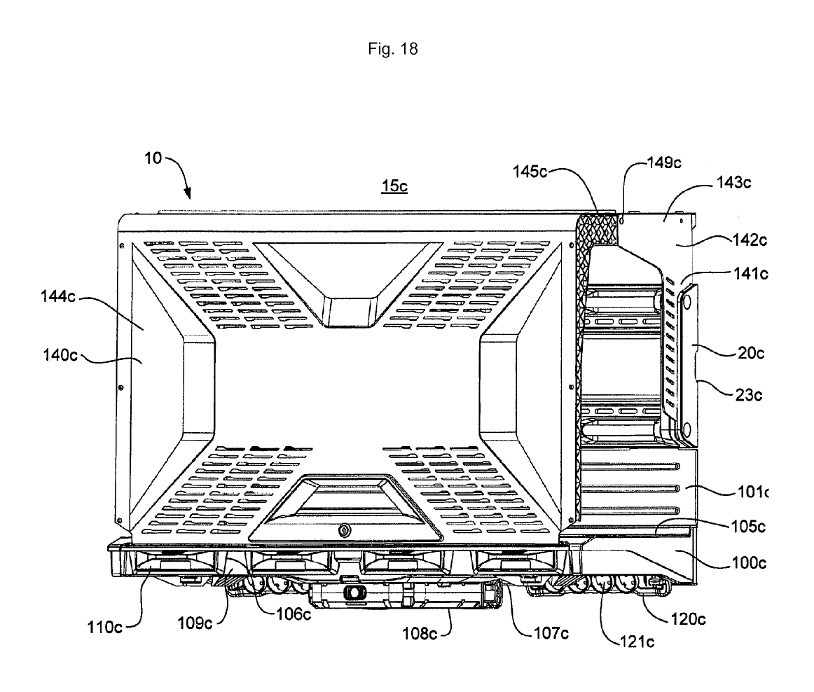

Referring to FIGS. 18 to 22, another embodiment of the support 20c is illustrated. The support 20c is a generally elongated member extending from a first end 21c to a second end 23c. The support 20c includes a generally planar and elongated base plate 22c that extends from the first end 21c to the second end 23c and includes a means of attachment to a surface 15c, such as a wall. Any suitable means such as fasteners, adhesives or the like can be utilised to attach the support 20c to the surface 15c. Attached to the base plate 22c is an elongated face plate 24c extending from the first end 21c to the second end 23c. When the support 20c is attached to the surface 15c the face plate 24c faces away from the surface 15c whereas the base plate 22c faces towards the surface 15c. The base plate 22c and the face plate 24c are configured so that when the support 20c is attached to the surface 15c the base plate 22c and the face plate 24c extend in a generally horizontal direction. The support 20c includes a first interface 70c that is adapted for interfacing with the second interface 80 of any one or more of the receptacles 40 in a manner that will be described herein below.

The first interface 70c extends continuously along the support 20c from the first end 21c to the second end 23c such that when the support 20c is attached to the surface 15c the first interface 70c extends continuously in a horizontal direction for releasable connection of a plurality of horizontally adjacent receptacles 40. The first interface 70c includes a plurality of horizontally spaced apart upper wall members 71c and lower wall members 73c that are upstanding from the face plate 24c. Between each adjacent pair of upper wall members 71c, are a pair of upper elongated support members 72c that extend between and to each of the adjacent pair of upper wall members 71c. Between each adjacent pair of lower wall members 73c are a pair of lower elongated support members 74c that extend between and to each of the adjacent pair of lower wall members 73c. The elongated upper and lower support members 72c, 74c are connected at opposite ends to each of an adjacent pair of the upper and lower wall members 71b, 73b respectively. The elongated upper and lower support members 72c, 74c respectively include a rounded supporting surface 75c, 77c extending in a substantially horizontal direction between and to each of the adjacent pair of wall members 71c, 73c. The upper support members 72c are positioned vertically above the lower support members 74c. The supporting surface 75c of each of the upper support members 72c faces generally upwardly. The supporting surface 77c of each of the lower support members 74c faces generally downwardly. The support members 72c, 74c are spaced apart from the face plate 24c such that an upwardly oriented opening 76c is provided between the upper support member 72c and the face plate 24c and a downwardly oriented opening 79c is provided between the lower support member 74c and the face plate 24c.

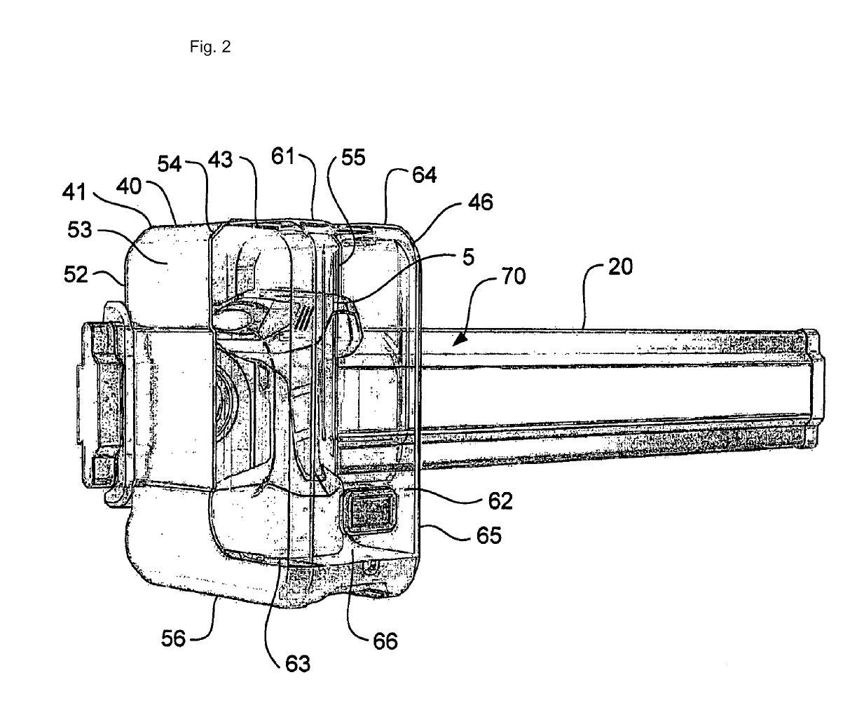

Referring to FIGS. 2, 14, 15 and 16, the receptacle 40 includes a base portion 41 and a closure member 46. In a preferred form, the tool receptable 40 is configured for receiving a releasably detachable power tool interface member (not shown) and a handheld power tool, such as a handheld power drill, there within. In another form, the tool receptable 40 is configured with an integrally formed power tool interface member. The base portion 41 and the closure member 46 are shaped to provide a generally box shaped member having a substantially hollow internal space 43 that is adapted for receiving one of the handheld power tools 5 there within. The base portion 41 includes a base wall 52, a pair of opposite side walls 53, 55 upstanding from the base wall 52 and a pair of opposite end walls 54, 56 upstanding from the base wall 52 and extending between the side walls 53, 55. The base wall 52, side walls 53, 55 and end walls 54, 56 of the base portion 41 define at least part of the internal space 43. The base wall 52 is configured for connection with the interface zone 70 of the support 20. Accordingly, when the base wall 52 is connected to the interface zone 70 of the support 20 the side walls 53, 55 and the end walls 54, 56 project outwardly from the support 20 and from the surface 15.

The closure member 46 includes a front wall 62, a pair of opposite side walls 63, 65 upstanding from the front wall 62 and pair of opposite end walls 64, 66 upstanding from the front wall 62 and extending between the side walls 63, 65. The closure member 46 is pivotally connected to the base portion 41 by a hinge connection 61 between an upper end wall 54 of the base portion 41 and an upper end wall 64 of the closure member 64. The hinge 61 facilitates pivotal movement of the closure member 46 relative to the base portion 41 between an open position and a closed position. When the closure member 46 is in the open position the portion of the internal space 43 defined within the base portion 41 can be accessed. When the closure member 46 is in the closed position the internal space 43 the front wall 62, opposite end walls 64, 66 and the opposite side walls 63, 65 define the remainder of the internal space 43 of the receptacle 40. Also, the internal space 43 within the receptacle 40 is enclosed when the closure member 46 is in the closed position.

Although not illustrated in the figures, the tool receptable 40 is configured for receiving a releasably detachable power tool interface member or includes an integrally formed power tool interface member. The power tool interface member is configured to receive the power tool in a manner so as to locate the power tool at a substantially fixed position relative to the interface member and relative to the receptacle in the internal space 43 within the receptacle 40 and, optionally, to retain the power tool. Accordingly, the interface member may take any suitable form adapted for this purpose. The interface member can include a chassis and power tool interface surface. The interface surface defines a recess that is shaped to receive the power tool. The chassis includes a base and a frame connected to, and extending from, the base. The base and the frame may be formed out of any suitable material such as a rigid or semi rigid polymer or metallic material having a rigidity and/or strength sufficient for the purpose of supporting a power tool. Thus, the interface member may be formed out of a durable polymer or metallic material. The interface surface is generally in the form of a surface that is recessed within the frame to form a recess or cavity having a shape that corresponds to, or conforms with, the shape of the external surface of the power tool or a least a portion of the external surface of the power tool to be positioned there within. For example, the interface surface may be shaped to conform to the external surface of a handheld power drill-type power tool. As will be appreciated, the interface surface can be designed for any one of a variety of power tools of types other than hand held power drills. The power tool interface member 40 may be configured to include an interface surface defining a recess for receiving any one of a variety of handheld power drills, handheld power saws, handheld power screwdrivers, handheld percussion/hammer drills, handheld angle grinders, handheld circular saws, handheld power sanders and other handheld electrical devices such as a light emitting device, such as a torch, a radio or any other hand held and/or portable electrical or electronic device to name but a few.

In another form, not illustrated in the figures, the receptacle 40 is configured for receiving a releasably detachable device interface member or includes an integrally formed interface member that is configured to receive one or more hand tools. The hand tools may include a set of spanners or wrenches, screwdrivers, socket wrenches or any other form of hand tool. The device interface member may be received within the receptacle 40 in such a manner as to be fixed within the internal space 43 within the receptacle 40. In another form, the device interface member may be received within the internal space 43 of the receptacle 40 in such a manner as to be movable relative to the receptacle 40 and to slide out of the internal space 43 to enable access to the hand tools.

In another form, not illustrated in the figures, the receptacle 40 may also include provision in the internal space 43 within the receptacle 40 for receiving releasably detachable storage containers for containing articles. Such storage containers may be configured for containing articles such as fasteners, screws, nails, tool bits, spare parts and accessories for tools such as hand held power tools. Such storage containers may include a container portion and a closure member for closing the container with articles inside.

As shown in FIGS. 12 to 16, the receptacle 40 includes a second interface or connecting portion 80 in the form of one or more flanges 85a, 85b upstanding and projecting from the base wall 52 of the base portion 41. The receptacle 40 may include one or both of the flanges 85a, 85b. The flanges 85a, 85b are generally L-shaped or hook shaped members that are spaced apart from each other by a substantially planar facing surface 86. When the second interface or connecting portion 80 is connected to the first interface 70, 70b, 70c one of the flanges 85a, 85b is received by the first interface 70, 70b, 70c of the support 20, 20b. In particular, one of the flanges 85a, 85b is received within the opening 75, 76b, 76c of the first interface 70, 70b, 70c and the facing surface 86 of the base portion 41 of the receptacle 40 faces towards the face plate 24, 24b, 24c of the support 20, 20b, 20c. When one of the flanges 85a, 85b is received within the opening 75, 76b, 76c one or more support surface engaging surfaces in the form of an inwardly curved, concave or hook shaped members 87a, 87b of the flange 85a, 85b engages the upwardly facing supporting surface 77, 73b, 75c of the first interface 70, 70b, 70c to thereby support at least part of the weight of the receptacle 40 upon the supporting surface 77, 73b, 75c. Engagement of the flange 85a, 85b within the opening 75, 76b, 76c retains the flange 85a, 85b in engagement with the first interface 70, 70b, 70c and thereby retains the base wall 52 of the base portion 41 face to face with the face plate 24, 24b, 24c of the support 20, 20b, 20c.

In the embodiment of the support 20 of FIGS. 1 to 11, adjacent pairs of the ridges 73 arranged at spaced apart intervals along the length of the ledge 72 are adapted to receive one of the flanges 85 therebetween to locate the receptacle 40 at predetermined positions along the length of the first interface 70.

In the embodiment of the support 20b of FIGS. 12, 13 and 17, the plurality of horizontally spaced apart wall members 71b are arranged at spaced apart intervals along the length of the ledge first interface 70b so as to receive one of the receptacles 40 therebetween at a predetermined position along the length of the first interface 70.

In the embodiment of the support 20c of FIGS. 18 to 22, the plurality of horizontally spaced apart upper wall members 71c and lower wall members 73c are arranged at spaced apart intervals along the length of the first interface 70c so as to receive one of the receptacles 40 between adjacent pairs of the spaced apart upper and lower wall members 71c, 73c at a predetermined position along the length of the interface 70c.

The support 20 and/or the receptacle 40 may include a latch mechanism (not shown) having an active condition wherein the latch is operable for retaining the receptacle 40 in connection with the support 20 and thereby preventing disconnection of the receptacle 40 from the support 20, 20b. The latch also has inactive condition wherein the receptacle 40 can be separated from the support 20, 20b so that the receptacle 40 can be transported to a location remote from the support 20, 20b.

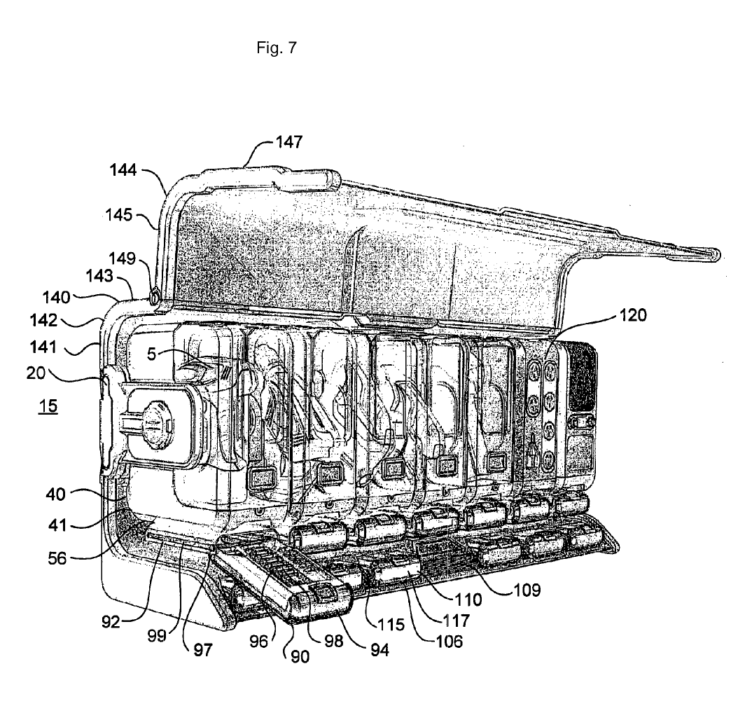

As can be seen in FIGS. 1, 4 to 8, 10 and 11, a tool accessory receptacle 90 is releasably connected to the receptacle 40. As shown in FIG. 7, the tool accessory receptacle 90 includes a mounting portion 92 and an accessory carrier member 94. The mounting portion 92 is releasably mountable to one of the end walls 56 of the base portion 41 of the receptacle 40. The accessory carrier member 94 is a tray member including one or more internal accessory carrying recesses 96 which, as shown in FIG. 7, are configured to receive any one or more of a plurality of accessories 98 for use with the power tool 5 received within and contained by the receptacle 40 to which the tool accessory receptacle 90 is attached. The accessories 98 may include drill or screwdriver bits for use with a drill type power tool 5. Alternatively, the accessories 98 may be saw blades for use with a jigsaw-type power tool 5. In another form, the accessories 98 may be grinding or cutting discs for use with an angle grinder-type power tool 5. In another form, the accessories 98 may be circular saw blades for use with a circular saw-type power tool 5.

The accessory carrier member 94 is slidably connected to the mounting portion 92 so as to be slidable relative to the mounting portion 92 between a closed position as shown in FIG. 1 and an open position as shown in FIG. 7. In the closed position shown in FIG. 1 the accessory carrying recesses 96 and the accessories 98 contained therein are enclosed by the mounting portion 92. In the open position shown in FIG. 7 the accessory carrying recesses 96 and the accessories 98 contained therein are accessible for insertion or removal thereof. The mounting portion 92 includes a pair of laterally positioned pins 97 that are slidably mounted within a laterally positioned elongated slot 99 within the mounting portion 92 to facilitate longitudinal sliding of the pins 97 therein and thereby facilitate the slidable movement of the accessory carrier member 94 relative to the mounting portion 92 between the closed and open positions. The tool accessory receptacle 90 may further include a locking device (not shown) that is operable for releasably locking the accessory carrier member 94 in the closed position relative to the mounting portion 92.

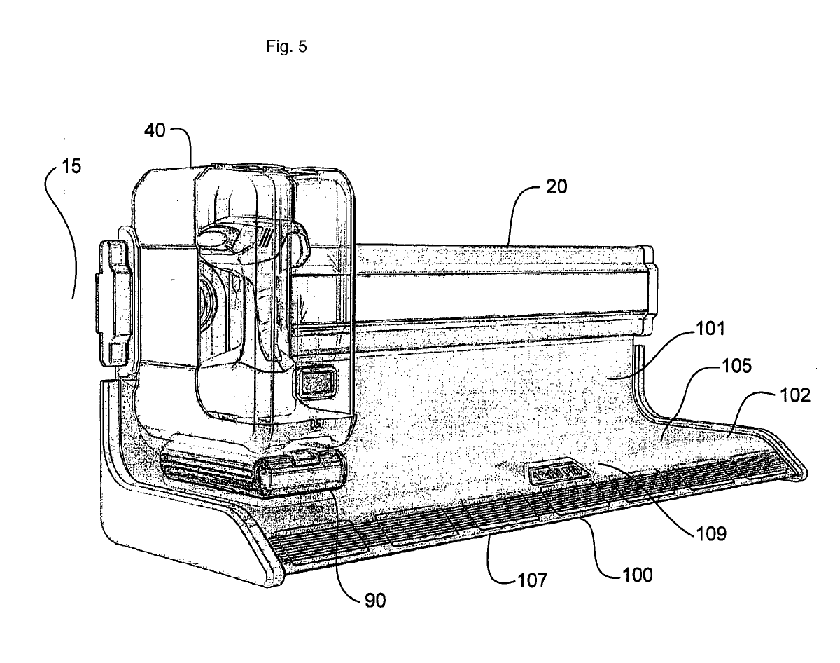

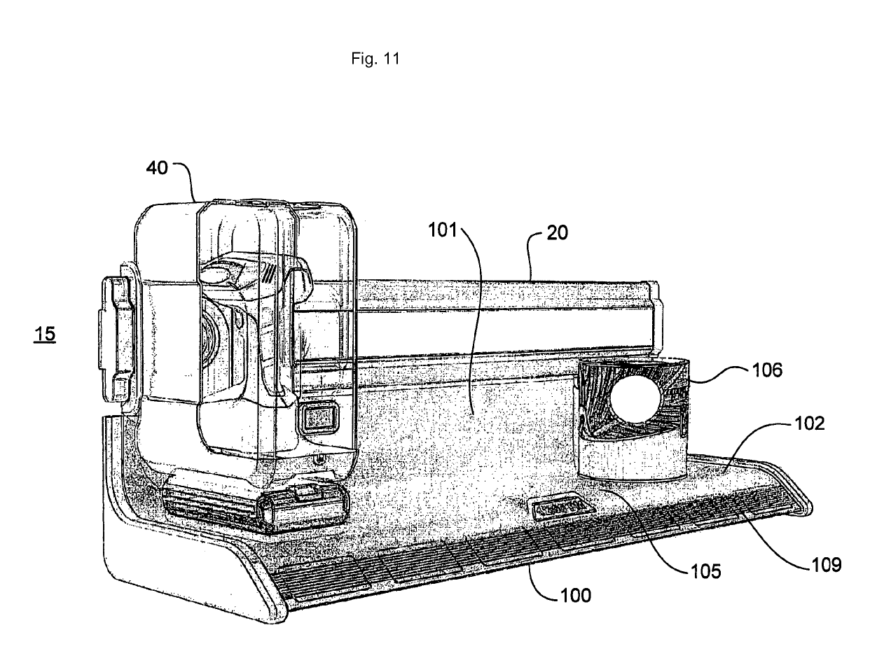

As shown in FIGS. 5 and 18 to 22, the storage system may further include a shelf member 100, 100c that is releasably connectable relative to the support 20, 20c by being connected to either the support 20, 20c or to the surface 15, 15c or to both the support 20, 20c and the surface 15, 15c or simply to the surface 15, 15c and positioned relative to the support. The shelf member 100, 100c is a generally elongated L-shaped member. When the shelf member 100, 100c is mounted relative to the support 20, 20c and the surface 15, 15c the shelf member 100, 100c includes a generally upright planar member 101, 101c and generally horizontal planar member 102, 102c extending from the upright member 101, 101c substantially perpendicularly therefrom. The upright planar member 101, 101c is operable for locating the shelf member 100, 100c relative to the support 20, 20c. The horizontal planar member 102, 102c has an upper planar surface 105, 105c that, when the shelf member 100, 100c is mounted relative to the support 20, 20c, is adapted to support articles thereon, such as a container 106 in the form of a paint tin as shown in FIG. 11 or any other object. Preferably, the planar support surface 105, 105c is substantially horizontal when the shelf member 100, 100c is mounted relative to the support 20, 20c.

Referring to FIGS. 3A to 3E, the first interface 70 of the support 20 also may include a second ledge 72A located intermediate of the bottom edge 25 and the top edge 26 of the base plate 22 and at a bottom edge 29 of the face plate 24. The second ledge 72A also includes a second opening 75A and a second supporting surface 77A. When the support 20 is mounted to the surface 15, the second ledge 72A, the second opening 75A and the second supporting surface 77A are vertically spaced apart from the first ledge 72, the first opening 75 and the first supporting surface 77 in a downwards direction. The second ledge 72A, the second opening 75A and the second supporting surface 77A have a similar structure to the first ledge 72, the first opening 75 and the first supporting surface 77 with the exception of being oriented in an opposite direction. The second ledge 72A, the second opening 75A and the second supporting surface 77A are adapted for releasable connection of the other one of the flanges 85a, 85b of the receptacle 40 not connected to the first ledge 72, the first opening 75 and the first supporting surface 77. Thus, when the receptacle 40 is connected to the support 20 the flanges 85a, 85b are respectively received within one of the first and second openings 75, 75A.

The first interface 70 may also be configured for attachment of the shelf member 100 thereto. Accordingly, in one form, the upright member 101 of the shelf member 100 may include a flange (not shown) that is adapted to be received within the second opening 75A of the first interface 70 and to engage the second supporting surface 77A of the first interface 70 to support the weight of the shelf member 100. Alternatively, the shelf member 100 may include apertures in an upper portion of the upright member 101 adapted to receive fasteners therethrough to mount the shelf member 100 to the support 20 or to the surface 15.

In the embodiment of the support 20b of FIGS. 12, 13 and 17, when the support 20b is mounted to the surface 15, the lower support member 74b and the supporting surface 75b thereof are vertically spaced apart in a downwards direction from the upper support member 72b and the supporting surface 73b thereof. The lower support member 74b, the downwardly oriented opening 77b and the lower supporting surface 75b are adapted for releasable connection of the other one of the flanges 85a, 85b of the receptacle 40 not connected to the upper support member 72b, the upwardly oriented opening 76b and the upper supporting surface 73b. Thus, when the receptacle 40 is connected to the support 20a the flanges 85a, 85b are respectively received within one of the upper and lower openings 76b, 77b.

In the embodiment of the support 20c of FIGS. 18 to 22, when the support 20c is mounted to the surface 15c the lower support member 74c and the supporting surface 77c thereof are vertically spaced apart in a downwards direction from the upper support member 72c and the supporting surface 75c thereof. The lower support member 74c, the downwardly oriented opening 79c and the lower supporting surface 77c are adapted for releasable connection of the other one of the flanges 85a, 85b of the receptacle 40 not connected to the upper support member 72c, the upwardly oriented opening 76c and the upper supporting surface 75c. Thus, when the receptacle 40 is connected to the support 20c by mounting the second interface 80 of the receptacle 40 to the first interface 70c of the support 20c the flanges 85a, 85b respectively engage the elongated upper and lower support members 72c, 74c. A first one of the support surface engaging surfaces in the form of the inwardly curved, concave or hook shaped portions 87a, 87b of one of the flanges 85a, 85b engages the outwardly curved or convex upwardly facing supporting surface 75c of the first interface 70c to thereby support at least part of the weight of the receptacle 40 upon the supporting surface 75c. A second one of the support surface engaging surfaces in the form of the second of the inwardly curved, concave or hook shaped portions 87a, 87b can be formed out of a resiliently deflectable material, such as sheet metal, so as to provide a detent. Referring to FIG. 16, the inwardly curved, concave or hook shaped portion 87b is formed out a resiliently deflectable material such that when the other one of the inwardly curved, concave or hook shaped members 87a is positioned to engage the upwardly facing supporting surface 75c the resiliently deflectable inwardly curved, concave or hook shaped member or detent 87b is capable of resiliently deflecting to enable engagement with the downwardly facing supporting surface 77c of the lower support member 74c. The largest overall dimension between the upwardly facing and downwardly facing supporting surfaces 75c, 77c is greater than the dimension between the support surface engaging surfaces 87a, 87b of the second interface 80 meaning. Thus, deflection of the resiliently deflectable inwardly curved, concave or hook shaped member or detent 87b is required to enable engagement between the first interface 70c and the second interface 80. Engaging and disengaging the resiliently deflectable inwardly curved, concave or hook shaped member or detent 87b from the downwardly facing outwardly curved or convex supporting surface 77c of the lower support member 74c involves manually tilting the receptacle 40 upwards about the upper support member 72c to cause the deflectable detent 87b to deflect and become engaged or disengaged from the downwardly facing outwardly curved or convex supporting surface 77c of the lower support member 74c.

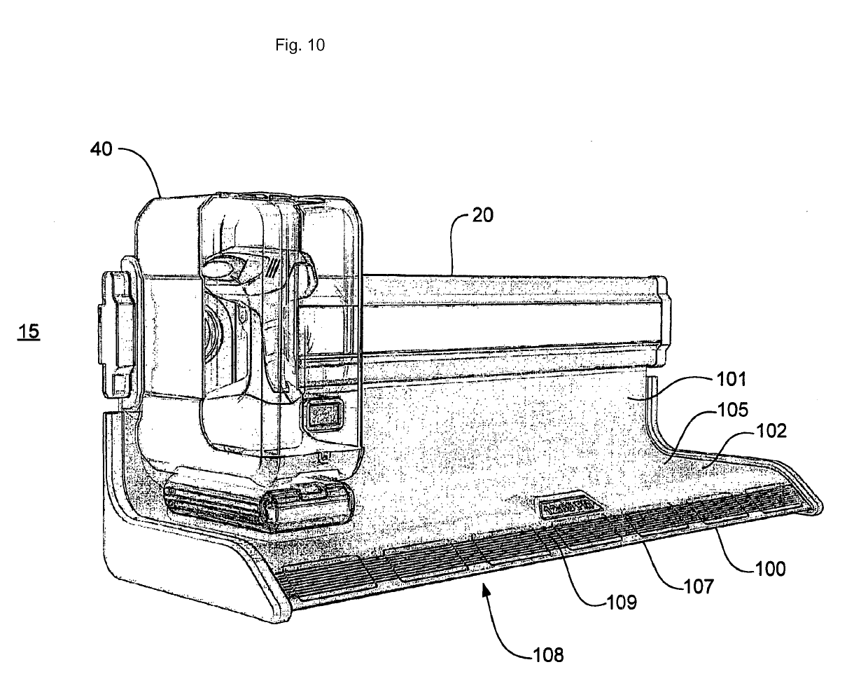

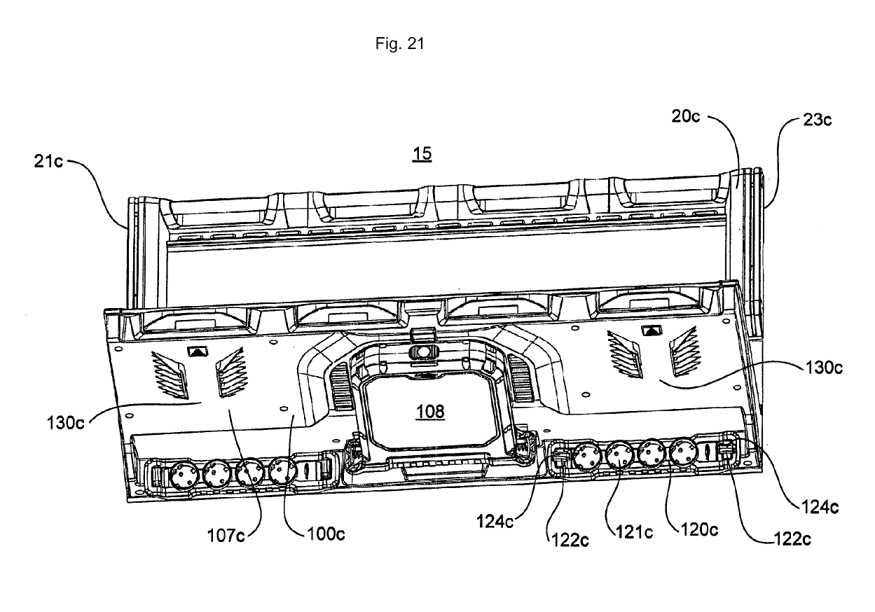

As shown in FIGS. 10, 18 and 20 to 22, the shelf member 100, 100c includes a light source 108, 108c located and mounted on a lower surface 107, 107c of the horizontal planar member 102, 102c. The lower surface 107, 107c being opposite to the planar supporting surface 105, 105c of the horizontal planar member 102, 102c of the shelf member 100, 100c. The light source 108, 108c is adapted to project light downwardly and outwardly from the lower surface 107, 107c of the shelf member 100, 100c to project light on to a work bench or other work surface located downwardly from the shelf member 100, 100c. The light source 108, 108c may be connected to a switch device for switching the light source 108, 108c on and off. In the embodiment illustrated in FIGS. 18 to 22 the light source 108c is releasably connectable to the lower surface 107c of the shelf member 100c. The light source 108c can include a rechargeable battery power supply (not shown) to provide power to the light source 108c when it is detached from the shelf member 100c. When attached to the shelf member 100c the battery power supply of the light source 108c can be recharged by attaching an electrical connector (not shown) of the light source 108c to a mains power supply. In another form, the shelf member 100 may include a clock 109 mounted within the planar supporting surface 105 thereof. As illustrated in FIG. 21, the lower surface 107c of the shelf member 100c includes a pair of attachment facilities 130c including a pair of spaced apart connecting members that each include an elongate flange so as to provide a pair of opposite elongate flanges capable of slidably receiving therebetween a variety of devices such as a clock module, a power control module of a modular power tool device or a charger for charging a removable battery of a battery powered power tool and the like.

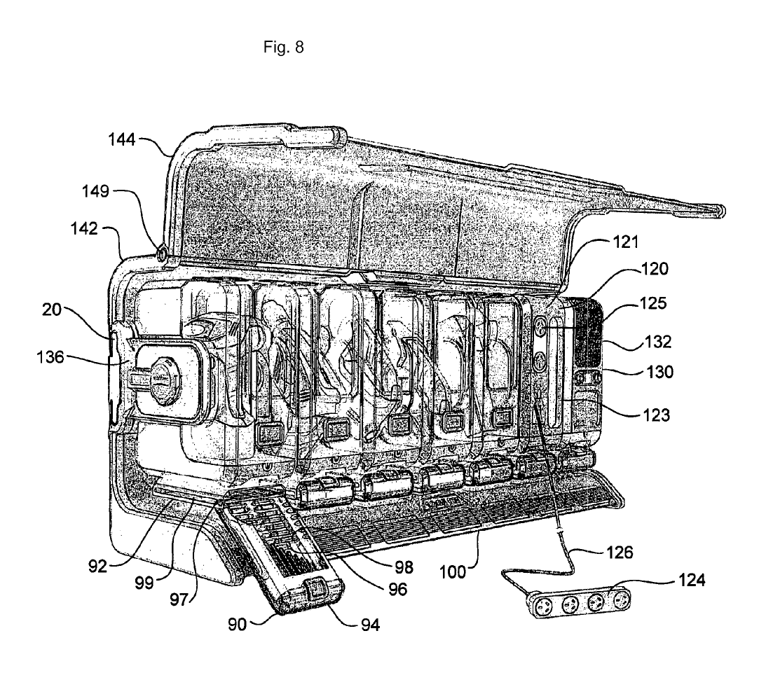

As shown in FIGS. 7 and 8 and 18 to 22, the storage system 10 may further include one or more article containers 110, 110c. The article containers 110, 110c are adapted to be releasably connected to the shelf member 100, 100c within one of a plurality of apertures 106, 106c within a downwardly extending ledge portion 109, 109c depending from the horizontal planar member 102, 102c. As shown in FIGS. 7 and 8 each of the article containers 1 10 includes a mounting portion 115 that is adapted to be mounted to the lower surface 107 of the horizontal planar member 102. The article container 110 further includes an article carrier member 117 that is slidably connected to the mounting portion 115 and is slidable between a closed position and an open position. In the closed position one or more article carrying recesses (not shown) within the article carrier member 117 are enclosed. In the open position the article carrying recesses within the article carrier member 117 are exposed and accessible to provide access to one or more articles (not shown) contained within the article carrying recesses of the article carrier member 117. Thus, the article container 110 is similar in operation to the tool accessory receptacle 90 described above with the exception that the article container 110 is adapted for connection to the shelf member 100 as opposed to the receptacle 40.

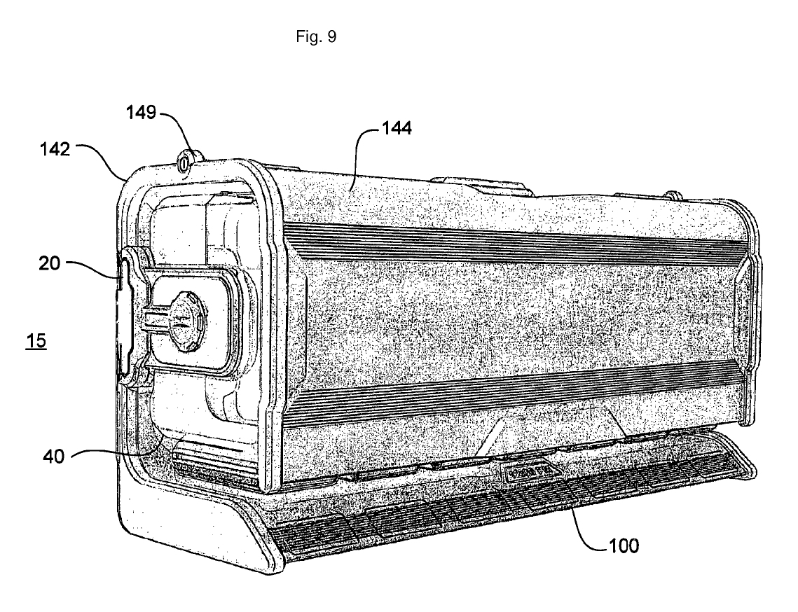

The assembly may further include, as shown in FIGS. 7 to 9, 18 and 19 a cover 140, 140c that is releasably connectable to the support 20, 20c. The cover 140, 140c includes a fixed member 142, 142c and a shutter member 144, 144c. The fixed member 142, 142c is an elongated member having a generally L-shaped profile and the shutter member 144, 144c is also an elongated member having a generally L-shaped profile. The fixed member 142, 142c is configured for releasable attachment to the support 20, 20c by any suitable means. For example, the fixed member 142, 142c may include a connection member (not shown) that is adapted for connection to the interface zone 70 of the support 20 or may include a plurality of apertures (not shown) adapted for receiving fasteners to fasten the fixed member 142, 142c to the support 20, 20c or to the surface 15, 15c. The fixed member 142, 142c has, when attached to the support 20, 20c or to the surface 15, 15c, an upright member 141, 141c and a horizontal member 143, 143c that extends at right angles from the upright member 141, 141c. The shutter 144, 144c includes a first member 145, 145c and a second member 147, 147c wherein the first and second members 145, 145c, 147, 147c extend at right angles to each other. The first member 145, 145c is pivotally mounted to the horizontal member 143, 143c of the fixed member 142, 142c by a hinge mechanism 149, 149c that facilitates pivotal movement of the shutter 144, 144c relative to the fixed member 142, 142c between an open position, as shown in FIGS. 7, 8 and 19, and a closed position as shown in FIGS. 9 and 18. When the cover 140, 140c is mounted to the support 20, 20c or the surface 15, 15c, the upright 141, 141c of the fixed member 142, 142c faces the surface 15, 15c and the horizontal member 143, 143c extends horizontally from the surface 15, 15c. When the shutter 144, 144c is in the open position the first member 145, 145c extends substantially vertically or over-centre from the horizontal member 143, 143c. When the shutter 144, 144c is in the closed position, the first member 145, 145c extends substantially horizontally from the horizontal member 143, 143c and the second member 147, 147c extends substantially vertically downwardly from the first member 145, 145c and the horizontal member 143, 143c. In the closed position, the shutter 144, 144c encloses the one or more receptacles 40 releasably connected to the support 20, 20c to prevent access and removal of the one or more receptacles 40 from the support 20, 20c. When the shutter 144, 144c is in the opened position, the one or more receptacles 40 connected to the support 20, 20c are accessible and can be connected to the support 20, 20c and removed from the support 20, 20c.

As shown in FIGS. 18 and 20 to 22, the storage system 10 may further include one or more power boards 120c that are releasably connectable to the support shelf member 100c. In particular, the power boards 120c are releasably connectable to the lower surface 107c of the shelf member 100c. The power boards 120c include a plurality of electrical sockets 121c for connection to one or more electrical plug connectors (not shown) of an electrically powered device. The power boards 120c include an electrical power lead and connector (not shown) for connection to mains power supply. The power boards 120c also include a pair of apertures 122c for receiving a pair of rotating locking connectors 124c connected to the lower surface 107c of the shelf member 100c. The rotating connectors 124c are receivable through the apertures 122c of the power board 120c and can be rotated to lock or unlock the power board 120c from the lower surface 107c of the shelf member 100c.

In another form, not illustrated in the Figures, the storage system 10 can further include an electronic device, such as a computer device, that is connectable to the Internet and includes a visual display and user input device that enables a user to connect to the Internet and access and/or download data or information and to store data or information. The device may include hardware that would typically be found in a personal computer such as a central processing unit, a memory or data storage device, an electronic display and a user input device. The device may also include a device for wireless connection to a broadband network such as a wireless Internet connection of an Internet Service Provider, a wireless Local Area Network such as an onboard wireless modem. The device may include a port, such as a USB port, for connection to an external modem for connection to a wireless or fixed cable network. The electronic device may be incorporated into a module similar to the power board module 120 and the audio module 130 described above. Thus, the electronic device module, or computer module, can be releasably connected to the support 20 in the same way, and by the same means, as the power board module 120 and the audio module 130 described above. The electronic device module, or computer module, is advantageous in that it enables a user to connect to and access the Internet to download, store and access information available from the Internet in relation to devices stored and contained by the storage system 10, such as user manuals and technical information. In one form, the electronic device module, or computer module, enables a user to access information available from the Internet in relation to the use of power tools and appropriate applications for power tools. In another form, the electronic device module, or computer module, enables a user to access other information available from the Internet such as instructions on various trades such as carpentry, electrical, plumbing and other trades as well as instructions to carry out various do-it-yourself projects such as building furniture, home improvement and the like.

As shown in FIGS. 12 and 13, the receptacle 40 includes a handle 42 that is mounted to the upper end wall 54 and the lower end wall 56 of the base portion 41. The handle 42 is pivotally attached to the base portion 41 and is adapted for gripping by a user to facilitate removal of the receptacle 40 from the support 20 and connection of the receptacle 40 to the support 20. The handle 42 is also adapted to facilitate carrying the receptacle 40 when the receptacle 40 is removed from the support 20.

The base portion 41 also includes either a clip (not shown) or a clip receiving portion (not shown) that is located on the internal surface of either the base wall 52, the side walls 53, 55 or the end walls 54, 56. Respectively, the clip or clip receiving portion is configured for releasable connection thereto of a clip receiving portion or clip of any one of a plurality of interchangeable power tool interfaces (not shown) when one of such power tool interfaces is positioned within the portion of the internal space 43 defined by the base portion 41. Such power tool interfaces are members that are shaped to receive a portion of one type of power tool therein. Accordingly, such interfaces are shaped to snugly receive a portion of one type of power tool therein to substantially hold the power tool within the portion of the internal space 43 of the receptacle 40 defined by the base portion 41 when the interface is releasably connected to the base portion 41 in the manner described above. Thus, the interface substantially prevents movement or excessive movement of the power tool 5 when positioned within the internal space 43 of the receptacle 40. Because the base portion 41 includes a clip or a clip receiving portion for releasable connection respectively with clip receiving portion or a clip of any one of a plurality of interchangeable power tool interfaces, the receptacle 40 can receive any one or more of a plurality of power tool interfaces for receiving any one or more of a variety of power tools 5 there within.

Finally, it is to be appreciated and understood that various alternations, modifications and/or additions may be introduced into the constructions and arrangements of the parts previously described without departing from the spirit or ambit of the invention.

1. A connection arrangement for releasably connecting, in a first mode of operation, a device receptacle and a support for attachment to a surface, the connection arrangement comprising:
a first connection interface associated with the support including at least one supporting surface;
a second connection interface associated with the device receptacle including a corresponding support surface; and
at least one of the support surfaces being removably engageable with a first one of the supporting surfaces to thereby support at least part of the weight of the device receptacle thereon,
wherein the support surfaces are removably engageable with each other to positively retain the first and second connection interfaces together, and
wherein, in a second mode of operation, the device receptable can be transported as a portable carry cabinet when demounted from the support surface.

2. The connection arrangement of claim 1, wherein the at least one support surface is outwardly curved and the at least one other support surface being inwardly curved.

3. The connection arrangement of claim 1, wherein the largest overall dimension between the pair of spaced apart supporting surfaces is greater than the dimension between the pair of spaced apart support surface engaging surfaces.

4. The connection arrangement of claim 1, wherein the support is an elongated member that is configured to extend horizontally when attached to a surface and comprises a plurality of horizontally adjacent first connection interfaces for releasable connection of a plurality of horizontally adjacent receptacles to the support.

5. The connection arrangement of claim 1, wherein at least one of the device receptacles is a hand held tool receptacle

6. A storage system for storing multiple power tools adjacent a surface comprising:
a support for attachment to the surface, and
at least one receptacle for receiving a power tool,
the receptacle being releasably connectable to the support.

7. The storage system of claim 6, wherein the support is an elongated member that is configured to extend horizontally when attached to a surface and comprises a plurality of the horizontally adjacent first connection interfaces for releasable connection of a plurality of horizontally adjacent receptacles to the support.

8. The storage system of claim 6, wherein the receptacle comprises a base portion and a closure member connected to the base portion, the base portion includes an internal space for receiving the power tool and the closure member is movable relative to the base portion between an open position to provide access to the internal space and a closed position to enclose the internal space.

9. The storage system of claim 6, further comprising a device accessory receptacle that is releasably connectable to the device receptacle for containing accessories for use with the device.

10. The storage system of claim 6, further comprising a shelf member that is connectable relative to the support.

11. The storage system of claim 10, wherein the shelf comprises a releasably connectable or an integral light source.

12. The storage system of claim 10, further comprising one or more article receptacles including a mounting portion that is releasably mountable to the shelf and an article carrier member including one or more article carrying recesses, the article carrier member being slidably connected to the mounting portion and slidable between a closed position to enclose the one or more article carrying recesses and an open position to provide access to the one or more article carrying recesses.

13. The storage system of claim 10, further comprising a power board including a plurality of electrical socket connectors releasably connectable to the shelf.

14. The storage system of claim 6, further comprising a cover that is releasably connectable relative to the support and pivots relative to the support between a closed position in which the cover encloses the device receptacle when connected to the support and an open position for providing access to the device receptacle when connected to the support.

15. The storage system of claim 6, wherein at least one of the device receptacles comprises an audio device containing an electronic system that plays an audio source over loudspeakers.

16. The storage system of claim 6, further including an electronic device module that comprises an electronic display and user interface and is connectable to a computer network and is capable of downloading data.

17. A storage system for storing power tools, the system comprising:
a frame for demountably supporting multiple carry cabinets, each carry cabinet being adapted to receive a power tool,
characterised in that,
said power tools can be inserted or removed through a port in their respective carry cabinet while said multiple carry cabinets are mounted on the frame, and
said power tools can be transported in their respective carry cabinets when each of said carry cabinets are demounted from the frame.

18. A storage system according to claim 17 wherein a carry cabinet can be changed between a mounted and a demounted configuration respectively by engaging and disengaging a latch between the carry cabinet and frame.

19. A storage system according to claim 17 which further comprises one or more further carry cabinets adapted to include a device chosen from the group comprising a power source, a power outlet having a retractable cord, a light, an audio device, a communications interface, a charging mat for an electronic device or combinations thereof.
